(19) United States
(12) Patent Application Publication
(10) Pub. No.: US 2026/0131448 A1
(43) Pub. Date: May 14, 2026

(54) Extendable Sawhorse Device

(71) Applicant: Antoan Simmons, Minot, ND (US)

(72) Inventor: Antoan Simmons, Minot, ND (US)

(21) Appl. No.: 18/946,158

(22) Filed: Nov. 13, 2024

(51) Int. Cl. B25H 1/08; B25H 1/06; B25H 1/10

(52) U.S. Cl. CPC B25H 1/08; B25H 1/06; B25H 1/10

(57) ABSTRACT

An extendable sawhorse device for securely holding a workpiece includes a pair of sawhorses that are spaced from each other. Each sawhorse includes a sawhorse beam having a sawhorse beam upper surface. A support is coupled to and extends downwardly from the sawhorse beam to position the sawhorse beam above a ground surface. A pair of cross members is coupled to and extends between the pair of sawhorses. Each cross member of the pair of cross members includes a cross member first end that is positioned proximate to a first sawhorse of the pair of sawhorses. A cross member second end is positioned proximate to a second sawhorse of the pair of sawhorses. A cross member top surface is coplanar with the sawhorse beam upper surface of the sawhorse beam.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to sawhorses and more particularly pertains to a new sawhorse for securely holding a workpiece.

### (2) Description of Related Art Including Information Disclosed Under 37 CFR 1.97 and 1.98

The prior art relates to sawhorses. Sawhorses are a common tool for carpenters, construction workers, and do it yourself enthusiasts. Sawhorses provide a sturdy frame for supporting a board, plank, or other workpiece while the user is sawing, cutting, sanding, or otherwise working on the workpiece. The prior art discloses various sawhorses adapted for use in myriad situations. For example, some sawhorses are collapsable or foldable to facilitate transport and storage. Some are made of wood, and others are made of plastic. Most sawhorses have a beam or work surface supported by a pair of legs. When the workpiece is large, however, it can be difficult for the user to balance the workpiece on the beam of the sawhorse while the user is working on the workpiece. To secure the workpiece, the user often needs the help of a friend or coworker who can hold the workpiece on the sawhorse as the user is completing their task. Thus, there is a need for a sawhorse device that can support large workpieces.

Ideally, such a device would releasably couple the workpiece to the sawhorse to secure a position of the workpiece as the user is working. Such a device would be particularly useful if the dimensions of the device could be adjusted to accommodate variously sized workpieces.

### BRIEF SUMMARY OF THE INVENTION

An embodiment of the disclosure meets the needs presented above by generally comprising a pair of sawhorses that are spaced from each other. Each sawhorse of the pair of sawhorses includes a sawhorse beam having a sawhorse beam upper surface. A support is coupled to the sawhorse beam. The support extends downwardly from the sawhorse beam wherein the support is configured to position the sawhorse beam above a ground surface. A pair of cross members is coupled to the pair of sawhorses. The pair of cross members extends between the pair of sawhorses wherein the pair of cross members couples the pair of sawhorses together. Each cross member of the pair of cross members includes a cross member first end that is positioned proximate to a first sawhorse of the pair of sawhorses. A cross member second end is positioned proximate to a second sawhorse of the pair of sawhorses. A cross member top surface is coplanar with the sawhorse beam upper surface of the sawhorse beam.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of an extendable sawhorse device according to an embodiment of the disclosure.

FIG. 2 is a front in-use view of an embodiment of the disclosure.

FIG. 3 is a side view of an embodiment of the disclosure.

FIG. 4 is a top view of an embodiment of the disclosure.

FIG. 5 is a detail view of an embodiment of the disclosure.

FIG. 6 is a detail view of an embodiment of the disclosure.

FIG. 7 is a front detail view of an embodiment of the disclosure.

FIG. 8 is an isometric view of an embodiment of the disclosure.

### DETAILED DESCRIPTION OF THE INVENTION

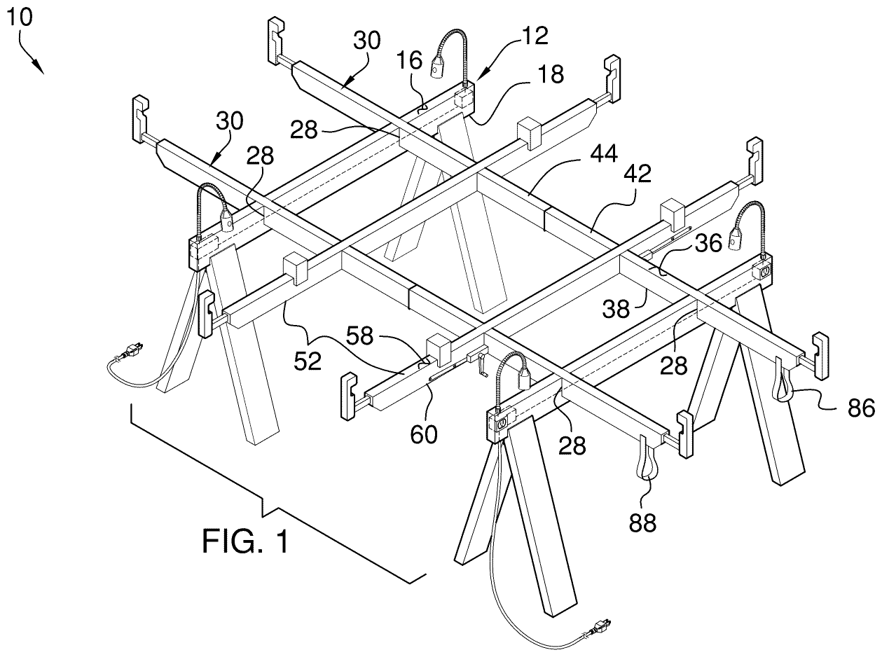

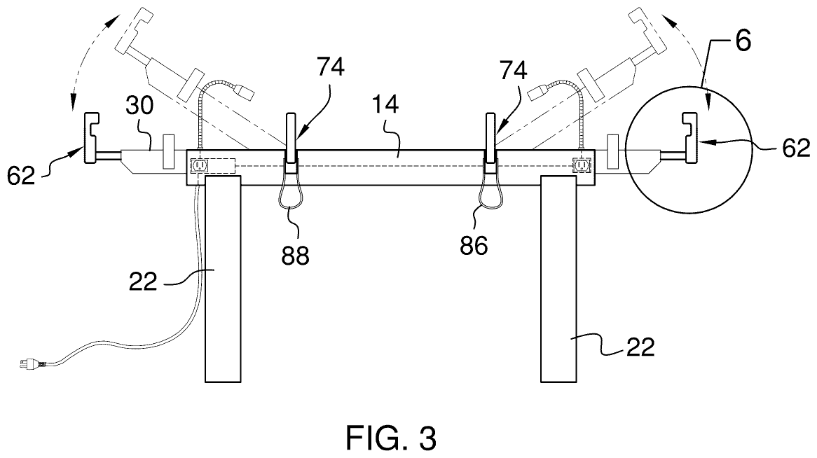

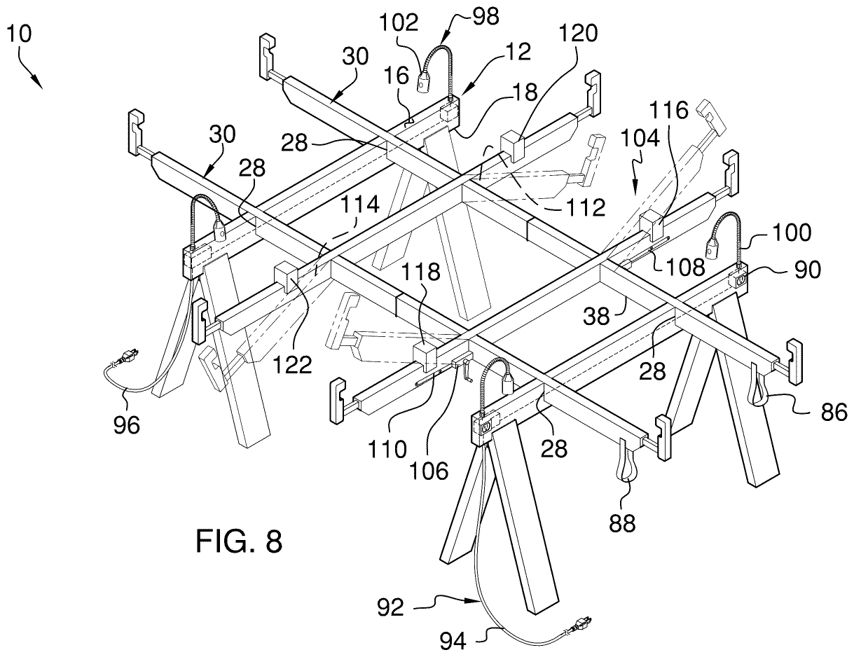

With reference now to the drawings, and in particular to FIGS. 1 through 8 thereof, a new sawhorse embodying the principles and concepts of an embodiment of the disclosure and generally designated by the reference numeral 10 will be described.

As best illustrated in FIGS. 1 through 8, the extendable sawhorse device 10 generally comprises a pair of sawhorses 12 are coupled together. The pair of sawhorses 12 are spaced from each other. The pair of sawhorses 12 may be parallel to each other. Each sawhorse of the pair of sawhorses 12 generally includes a sawhorse beam 14 and a support 22 extending downwardly from the sawhorse beam 14.

The sawhorse beam 14 generally comprises a sawhorse beam upper surface 16 and a sawhorse beam lower surface 18. The sawhorse beam 14 may have a pair of sawhorse beam lateral ends 20. The sawhorse beam upper surface 16 and the sawhorse beam lower surface 18 extend between the pair of sawhorse beam lateral ends 20.

The support 22 may extend downwardly from the sawhorse beam lower surface 18. The support 22 is configured to position the sawhorse beam 14 above a ground surface. The sawhorse beam 14 may be removably couplable to the support 22. For example, the support 22 may include a pair of legs 24 that extend outwardly and downwardly from opposing sides of the sawhorse beam 14. The sawhorse beam 14 may be positionable between the pair of legs 24 to couple the sawhorse beam to the support 22. The pair of legs 24 may be pivotably coupled together wherein the pair of legs 24 are pivotable toward each other when the sawhorse beam 14 is removed from between the pair of legs 24. A leg hinge 26 may couple the pair of legs 24 together. The leg hinge 26 may be positioned beneath the sawhorse beam 14 when the sawhorse beam 14 is coupled to the pair of legs 24.

Some embodiments may include a pair of supports 22, as shown in the Figures. Each support 22 of the pair of supports 22 may be positioned proximate to a respective sawhorse beam lateral end of the pair of sawhorse beam lateral ends 20 wherein the pair of supports 22 are spaced from each other.

A pair of beam notches 28 may extend into the sawhorse beam upper surface 16 of the sawhorse beam 14. The pair of beam notches 28 are generally spaced from each other. For example, each beam notch of the pair of beam notches 28 may be positioned between a sawhorse beam center and an associated sawhorse beam lateral end of the pair of sawhorse beam lateral ends 20. Each support 22 of the pair of supports 22 may be positioned between the pair of beam notches 28 and the associated sawhorse beam lateral end of the pair of sawhorse beam lateral ends 20.

A pair of cross members 30 is coupled to the pair of sawhorses 12. The pair of cross members 30 extend between the pair of sawhorses 12 wherein the pair of cross members 30 couple the pair of sawhorses 12 together. The pair of cross members 30 may be perpendicular to the sawhorse beam 14 of each sawhorse of the pair of sawhorses 12.

The pair of cross members 30 may be removably couplable to each sawhorse of the pair of sawhorses 12. For example, the pair of cross members 30 may be positioned within the pair of beam notches 28 when the pair of cross members 30 are coupled to each sawhorse of the pair of sawhorses 12. Accordingly, a cross member width may be complementary to a respective beam notch width of each beam notch of the pair of beam notches 28 wherein each cross member is positionable within each beam notch of the pair of beam notches 28.

Each cross member of the pair of cross members 30 may include a cross member first end 32, which may be positioned proximate to a first sawhorse of the pair of sawhorses 12. A cross member second end 34 may be positioned proximate to a second sawhorse of the pair of sawhorses 12. A cross member length between the cross member first end 32 and the cross member second end 34 may exceed a distance between the pair of sawhorses 12 wherein each of the pair of cross members 30 extends past each of the pair of sawhorses 12.

A cross member top surface 36 is generally coplanar with the sawhorse beam upper surface 16 of the sawhorse beam 14 of each sawhorse of the pair of sawhorses 12. For example, each cross member of the pair of cross members 30 may have a cross member height that is complementary to a respective beam notch height of each beam notch of the pair of beam notches 28. When positioned within the pair of beam notches 28, a cross member bottom surface 38 may be spaced from the sawhorse beam lower surface 18.

A break 40 may extending through each cross member of the pair of cross members 30 to define a cross member first portion 42 and a cross member second portion 44. The break 40 may be centrally positioned along the cross member length wherein the cross member first portion 42 has a cross member first portion length that is equivalent to a cross member second portion length of the cross member second portion 44. The cross member first end 32 is generally positioned on the cross member first portion 42. The cross member second end 34 is generally positioned on the cross member second portion 44.

A cross member hinge 46 may pivotably couple the cross member first portion 42 to the cross member second portion 44 wherein each cross member of the pair of cross members 30 is pivotable between a cross member storage position 48 and a cross member extended position 50. For example, the cross member first portion 42 may be folded against the cross member second portion 44 when each cross member 30 is in the cross member storage position 48.

The cross member hinge 46 may be positioned on the cross member bottom surface 38 of each cross member 30 wherein the cross member top surface 36 of the cross member first portion 42 faces away from the cross member top surface 36 of the cross member second portion 44 when the cross member is in the cross member storage position 48. The cross member first portion 42 is generally parallel to the cross member second portion 44 when the cross member is in the cross member extended position 50. The cross member top surface 36 of the cross member first portion 42 is generally coplanar with the cross member top surface 36 of the cross member second portion 44 when the cross member is in the cross member extended position 50.

A pair of rails 52 may be coupled to the pair of cross members 30. The pair of rails 52 may extend between the pair of cross members 30. A rail top side 58 of each rail of the pair of rails 52 is generally coplanar with the cross member top surface 36. A rail bottom side 60 of each rail of the pair of rails 52 may be coplanar with the cross member bottom surface 38.

The pair of rails 52 may be perpendicular to the pair of cross members 30. The pair of rails 52 may be spaced from each other. For example, a first rail of the pair of rails 52 may be positioned on the cross member first portion 42 of each cross member 30 and a second rail of the pair of rails 52 may be positioned on the cross member second portion 44 of each cross member 30.

The pair of rails 52 may be positioned between the pair of sawhorses 12 when the pair of cross members 30 is coupled to the pair of sawhorses 12. The pair of rails 52 is generally spaced from the pair of sawhorses 12. For example, the first rail of the pair of rails 52 may be positioned between the break 40 and the first sawhorse of the pair of sawhorses 12, while the second rail of the pair of rails 52 is positioned between the break 40 and the second sawhorse of the pair of sawhorses 12.

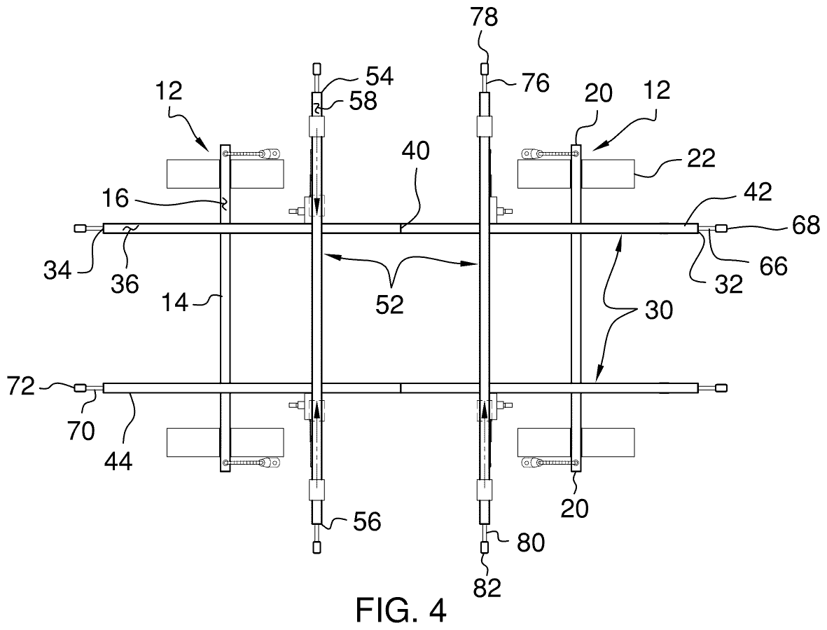

Each rail of the pair of rails 52 may include a rail primary end 54 that is positioned proximate to a first cross member of the pair of cross members 30. A rail secondary end 56 may be positioned proximate to a second cross member of aid pair of cross members 30. A rail length between the rail primary end 54 and the rail secondary end 56 may exceed a distance between the pair of cross members 30 wherein the pair of rails 52 extend past each cross member of the pair of cross members 30. As shown in FIG. 4, the rail length may also exceed a sawhorse beam 14 length between the pair of sawhorse beam lateral ends 20.

A cross member clamp 62 may be coupled to each cross member of the pair of cross members 30. The cross member clamp 62 is configured to releasably engage a workpiece 64 wherein the cross member clamp 62 is configured to releasably secure the workpiece 64 to each cross member of the pair of cross members 30.

A cross member first portion clamp arm 66 may be telescopically coupled to the cross member first portion 42 of each cross member 30. For example, the cross member first portion clamp arm 66 may be nested within the cross member first portion 42. The cross member first portion clamp arm 66 may be extendable and retractable relative to the cross member first end 32 of each cross member of the pair of cross members 30.

A cross member first portion clamp fin 68 may be coupled to the cross member first portion clamp arm 66. The cross member first portion clamp fin 68 extends upwardly from the cross member first portion clamp arm 66. The cross member first portion clamp fin 68 is configured to hold an edge of the workpiece 64 to releasably secure the workpiece 64 to the cross member first portion 42 of each cross member of the pair of cross members 30.

A cross member second portion clamp arm 70 may be telescopically coupled to the cross member second portion 44. For example, the cross member second portion clamp arm 70 may be nested within the cross member second portion 44. The cross member second portion clamp arm 70 may be extendable and retractable relative to the cross member second end 34 of each cross member of the pair of cross members 30.

A cross member second portion clamp fin 72 may be coupled to the cross member second portion clamp arm 70. The cross member second portion clamp fin 72 extends upwardly from the cross member second portion clamp arm 70. The cross member second portion clamp fin 72 is configured to hold the edge of the workpiece 64 to releasably secure the workpiece 64 to the cross member second portion 44 of each cross member of the pair of cross members 30.

A rail clamp 74 may be coupled to each rail of the pair of rails 52. The rail clamp 74 is configured to releasably engage the workpiece 64. The rail clamp 74 is configured to releasably secure the workpiece 64 to each rail of the pair of rails 52.

A rail clamp primary arm 76 may be telescopically coupled to the rail primary end 54 of each rail of the pair of rails 52. For example, the rail clamp primary arm 76 may be nested within the rail primary end 54. The rail clamp primary arm 76 is extendable and retractable relative to the rail primary end 54.

A rail clamp primary fin 78 may be coupled to the rail clamp primary arm 76. The rail clamp primary fin 78 extends upwardly from the rail clamp primary arm 76. The rail clamp primary fin 78 is configured to hold the edge of the workpiece 64 to releasably secure the workpiece 64 to the rail primary end 54 of each rail of the pair of rails 52.

A rail clamp secondary arm 80 may be telescopically coupled to the rail secondary end 56 of each rail of the pair of rails 52. For example, the rail clamp secondary arm 80 may be nested within the rail secondary end 56. The rail clamp secondary arm 80 may be extendable and retractable relative to the rail secondary end 56.

A rail clamp secondary fin 82 may be coupled to the rail clamp secondary arm 80. The rail clamp secondary fin 82 extends upwardly from the rail clamp secondary arm 80. The rail clamp secondary fin 82 is configured to hold the edge of the workpiece 64 to releasably secure the workpiece 64 to the rail secondary end 56 of each rail of the pair of rails 52.

A retainer 84 may be coupled to each cross member of the pair of cross members 30. For example, the retainer 84 may be positioned on the cross member second portion 44 of each cross member of the pair of cross members 30. The retainer 84 releasably engages the cross member first portion 42 when each cross member of the pair of cross members 30 is in the cross member storage position 48. The retainer 84 inhibits each cross member of the pair of cross members 30 from unfolding into the cross member extended position 50.

Certain embodiments of the retainer 84 include a first strap 86 that is coupled to a first cross member of the pair of cross members 30. The first strap 86 may be positioned adjacent to the cross member second end 34 of the first cross member of the pair of cross members 30. The first strap 86 may extend downwardly from the first cross member of the pair of cross members 30. A second strap 88 may be coupled to a second cross member of the pair of cross members 30. The second strap 88 may be positioned adjacent to the cross member second end 34 of the second cross member of the pair of cross members 30. The second strap 88 may extend downwardly from the second cross member of the pair of cross members 30. The second strap 88 may be aligned with the first strap 86.

A plurality of power outlets 90 may be coupled to the pair of sawhorses 12. For example, each power outlet of the plurality of power outlets 90 may be inset into the sawhorse beam 14 of each sawhorse of the pair of sawhorses 12. Each power outlet of the plurality of power outlets 90 may be exposed within the sawhorse beam 14 of each sawhorse of the pair of sawhorses 12. Each power outlet of the plurality of power outlets 90 may be positioned adjacent to a respective sawhorse beam lateral end of the pair of sawhorse beam lateral ends 20 of the sawhorse beam 14 of each sawhorse of the pair of sawhorses 12. In such embodiments, the plurality of power outlets 90 may include a total of four power outlets, with one power outlet positioned near each corner of the extendable sawhorse device 10. The plurality of power outlets 90 may be used to transfer power to power tools being used on the workpiece 64. For example, a power drill could be plugged into a first outlet of the plurality of outlets 90 and an electric saw could be plugged into a second outlet of the plurality of outlets 90. An internal power source may be electrically coupled to the plurality of power outlets 90 to transfer power to each power outlet of the plurality of power outlets 90.

A power input 92 may be electrically coupled to the plurality of power outlets 90. The power input 92 is generally configured to be electrically couplable to an extrinsic power source (not shown) wherein the power input 92 is configured to transfer power from the extrinsic power source to the plurality of power outlets 90. For example, the power input 92 may include a first power cord 94 that is coupled to and extends from the first sawhorse of the pair of sawhorses 12 and a second power cord 96 that is coupled to and extends from the second sawhorse of the pair of sawhorses 12. The power input 92 may also be electrically coupled to the internal power source wherein the power input 92 transfers power from the extrinsic power source to the internal power source.

A plurality of lamps 98 may be electrically coupled to the power input 92 wherein the power input 92 is configured to transfer power from the extrinsic power source to the plurality of lamps 98. The plurality of lamps 98 may be coupled to the pair of sawhorses 12. Each lamp of the plurality of lamps 98 may be positioned proximate to an associated power outlet of the plurality of power outlets 90, although alternative configurations are also contemplated. The plurality of lamps 98 are generally configured to emit light onto the workpiece 64 to facilitate visibility of the workpiece 64.

For example, each lamp of the plurality of lamps 98 may include a lamp neck 100 that extends upwardly from the sawhorse beam upper surface 16 of the sawhorse beam 14 of a respective sawhorse of the pair of sawhorses 12. A lamp head 102 may be coupled to the lamp neck 100 distally to the sawhorse beam upper surface 16. The lamp neck 100 may be flexible wherein a position of the lamp head 102 is adjustable and wherein light emitted from the lamp head 102 is configured to be selectively directable toward the workpiece 64 whereby the plurality of lamps 98 is configured to facilitate visibility of the workpiece 64. For example, each lamp of the plurality of lamps 98 may be a gooseneck lamp.

A plurality of spacers 104 may be coupled to the pair of rails 52. The plurality of spacers 104 generally extend upwardly from the rail top side 58 of each rail of the pair of rails 52 wherein the plurality of spacers 104 is configured to space the workpiece 64 from the pair of rails 52 to inhibit damage to the pair of rails 52. For example, the workpiece 64 may rest on top of the pair of rails 52 to inhibit a saw from cutting through the pair of rails 52 when the saw is used to cut the workpiece 64. Each spacer of the plurality of spacers 104 may accordingly have a height between 3.5 inches and 6.5 inches. Each spacer of the plurality of spacers 104 may comprise a rubber material that is configured to inhibit damage to the workpiece 64.

The plurality of spacers 104 may include a first spacer 116 that is coupled to the first rail of the pair of rails 52. The first spacer 116 may be positioned proximate to the rail primary end 54 of the first rail of the pair of rails 52. The first spacer 116 may be slidably coupled to the first rail wherein the first spacer 116 is slidable along the rail length of the first rail to selectively adjust a distance between the first spacer 116 and the rail primary end 54 of the first rail.

A second spacer 118 may be coupled to the first rail of the pair of rails 52. The second spacer 118 may be positioned proximate to the rail secondary end 56 of the first rail of the pair of rails 52. The second spacer 118 may be slidably coupled to the first rail wherein the second spacer 118 is slidable along the rail length of the first rail to selectively adjust a distance between the second spacer 118 and the rail secondary end 56 of the first rail.

A third spacer 120 may be coupled to the second rail of the pair of rails 52. The third spacer 120 may be positioned proximate to the rail primary end 54 of the second rail of the pair of rails 52. The third spacer 120 may be slidably coupled to the second rail wherein the third spacer 120 is slidable along the rail length of the second rail to selectively adjust a distance between the third spacer 120 and the rail primary end 54 of the second rail.

A fourth spacer 122 may be coupled to the second rail of the pair of rails 52. The fourth spacer 122 may be positioned proximate to the rail secondary end 56 of the second rail of the pair of rails 52. The fourth spacer 122 may be slidably coupled to the second rail wherein the fourth spacer 122 is slidable along the rail length of the second rail to selectively adjust a distance between the fourth spacer 122 and the rail secondary end 56 of the second rail.

A plurality of crank mechanisms 106 may be coupled to the pair of rails 52. Each of the plurality of crank mechanisms 106 is actuatable to pivot a respective rail of the pair of rails 52 upwardly and downwardly relative to the pair of cross members 30 wherein the plurality of crank mechanisms 106 is configured to stabilize the workpiece 64 on the extendable sawhorse device 10.

For example, a first crank 108 may be coupled to the first rail of the pair of rails 52. The first crank 108 may be actuatable to pivot the first rail upwardly and downwardly such that a position of the rail primary end 54 of the first rail is adjustable relative to the pair of cross members 30.

A second crank 110 may also be coupled to the first rail of the pair of rails 52. The second crank 110 may be actuatable to pivot the first rail upwardly and downwardly such that a position of the rail secondary end 56 of the first rail is adjustable relative to the pair of cross members 30.

A third crank 112 may be coupled to the second rail of the pair of rails 52. The second crank 112 may be actuatable to pivot the second rail upwardly and downwardly such that a position of the rail primary end 54 of the second rail is adjustable relative to the pair of cross members 30.

A fourth crank 114 may be coupled to the second rail of the pair of rails 52. The fourth crank 114 may be actuatable to pivot the second rail upwardly and downwardly such that a position of the rail secondary end 56 of the second rail is adjustable relative to the pair of cross members 30.

In use, the extendable sawhorse device 10 provides a stable surface for the workpiece 64. The pair of cross members 30 extend between the pair of sawhorses 12 to increase the surface area on which the workpiece 64 can rest. The pair of rails 52 extending between the pair of cross members 30 further increase that surface area. Each of the cross member length and the rail length can each be adjusted by selectively extending and retracting each of cross member first portion clamp arm 66, the cross member second portion clamp arm 70, the rail clamp primary arm 76, and the rail clamp secondary arm 80. This extension and retraction is configured to facilitate the user in adjusting the surface area on which the workpiece 64 rests based on the particular dimensions of the workpiece 64.

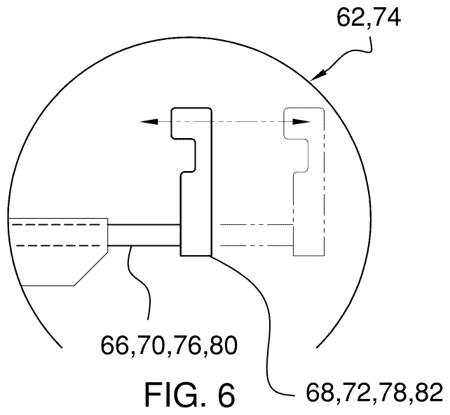

The workpiece 64 can be releasably secured using the cross member clamp 62 and the rail clamp 74. The position of the cross member clamp 62 and the rail clamp 74 can each be independently adjusted to accommodate the size of the work piece. For example, the cross member first portion clamp arm 66 can be extended relative to the cross member first end 32 when the size of the workpiece 64 exceeds the cross member length. Similarly, the rail clamp primary arm 76 can be extended relative to the rail primary end 54 when the size of the work piece exceeds the rail length. FIG. 6 provides an exemplary depiction.

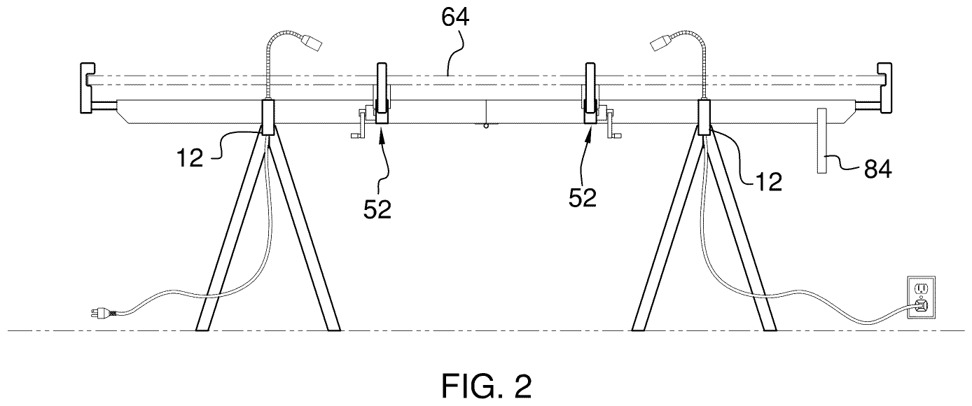

A second user is not needed to hold the workpiece 64 because the workpiece 64 can be releasably secured to the pair of cross members 30 using the cross member first portion clamp fin 68 and the cross member second portion clamp fin 72. Similarly, the workpiece 64 can be releasably secured to the pair of rails 52 using the rail clamp primary fin 78 and the rail clamp secondary fin 82. FIG. 2 provides an exemplary depiction. As the center of gravity of the workpiece 64 changes, for example because the workpiece 64 is cut or because additional pieces are coupled to the workpiece 64, the plurality of crank mechanisms 106 can be actuated to stabilize a position of the workpiece 64 on the pair of sawhorses 12, the pair of cross members 30, and the pair of rails 52.

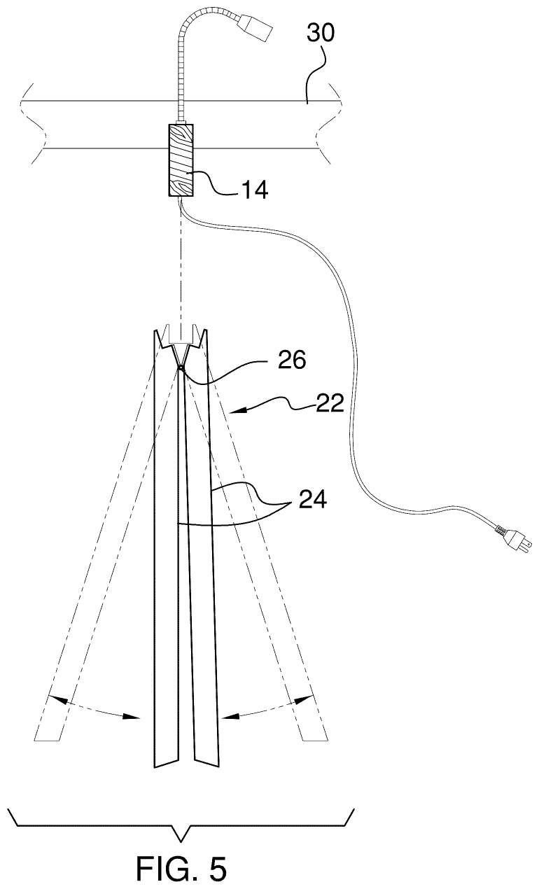

To facilitate storage and transport, the pair of sawhorses 12 can be removed from the pair of cross members 30 and the pair of rails 52. The pair of legs 24 of each support 22 may be pivoted together. In embodiments according to FIG. 5, the sawhorse beam 14 may be removed from between the pair of legs 24 to further facilitate storage and transport of the extendable sawhorse device 10. Similarly, the pair of cross members 30 may be removed from the pair of beam notches 28 within the sawhorse beam 14 of each sawhorse of the pair of sawhorses 12.

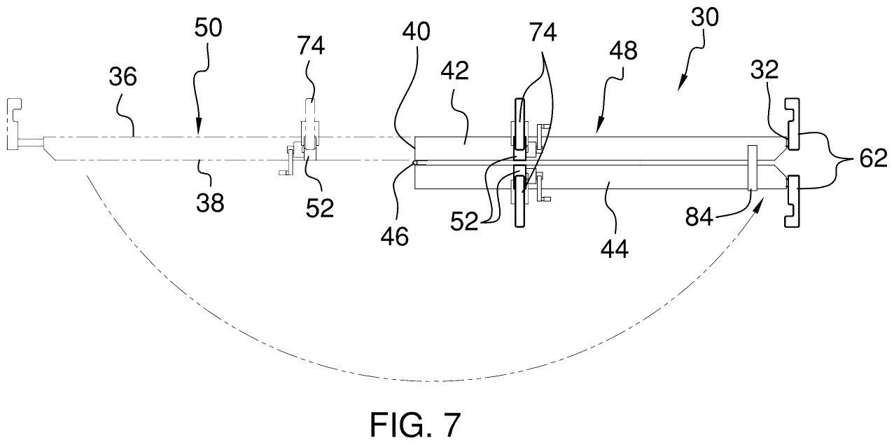

The break 40 allows the pair of cross members 30 to be folded or pivoted together, facilitating storage and transport. The pair of cross members 30 may be pivoted together once the pair of cross members 30 are removed from the pair of sawhorses 12. Alternatively, the pair of cross members 30 may be pivoted together while the pair of cross members 30 are attached to the pair of sawhorses 12 because the cross member hinge 46 is positioned on the cross member bottom surface 38. To retain the pair of cross members 30 in the cross member storage position 48, the retainer 84 may be used. For example, the first strap 86 may be wrapped around the cross member first portion 42 of the first cross member of the pair of cross members 30. The second strap 88 may be wrapped around the cross member first portion 42 of the second cross member of the pair of cross members 30. FIG. 7 provides an exemplary depiction of the pair of cross members 30 in the cross member storage position 48.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A workpiece support assembly comprising:
a pair of sawhorses being spaced from each other, each sawhorse of the pair of sawhorses including:
a sawhorse beam having a sawhorse beam upper surface;
a support being coupled to the sawhorse beam, the support extending downwardly from the sawhorse beam wherein the support is configured to position the sawhorse beam above a ground surface; and
a pair of cross members being coupled to the pair of sawhorses, the pair of cross members extending between the pair of sawhorses wherein the pair of cross members couples the pair of sawhorses together, each cross member of the pair of cross members including:
a cross member first end being positioned proximate to a first sawhorse of the pair of sawhorses;
a cross member second end being positioned proximate to a second sawhorse of the pair of sawhorses; and
a cross member top surface being coplanar with the sawhorse beam upper surface of the sawhorse beam.

2. The workpiece support assembly of claim 1, further comprising a cross member clamp being coupled to each cross member of the pair of cross members, the cross member clamp being configured to releasably engage a workpiece wherein the cross member clamp is configured to releasably secure the workpiece to each cross member of the pair of cross members.

3. The workpiece support assembly of claim 2, the cross member clamp further comprising:
a cross member first portion clamp arm being telescopically coupled to the cross member, the cross member first portion clamp arm being nested within the cross member wherein the cross member first portion clamp arm is extendable and retractable relative to the cross member first end of each cross member of the pair of cross members;
a cross member first portion clamp fin being coupled to the cross member first portion clamp arm, the cross member first portion clamp fin extending upwardly from the cross member first portion clamp arm wherein the cross member first portion clamp fin is configured to hold an edge of the workpiece to releasably secure the workpiece to the cross member first end of each cross member of the pair of cross members;
a cross member second portion clamp arm being telescopically coupled to the cross member, the cross member second portion clamp arm being nested within the cross member wherein the cross member second portion clamp arm is extendable and retractable relative to the cross member second end of each cross member of the pair of cross members; and
a cross member second portion clamp fin being coupled to the cross member second portion clamp arm, the cross member second portion clamp fin extending upwardly from the cross member second portion clamp arm wherein the cross member second portion clamp fin is configured to hold the edge of the workpiece to releasably secure the workpiece to the cross member second end of each cross member of the pair of cross members.

4. The workpiece support assembly of claim 1, further comprising a pair of rails being coupled to the pair of cross members, the pair of rails extending between the pair of cross members.

5. The workpiece support assembly of claim 4, each rail of the pair of rails further comprising a rail top side being coplanar with the cross member top surface.

6. The workpiece support assembly of claim 4, each rail of the pair of rails further comprising:
a rail primary end;
a rail secondary end; and
a rail length between the rail primary end and the rail secondary end exceeding a distance between the pair of cross members wherein the pair of rails extend past each cross member of the pair of cross members.

7. The workpiece support assembly of claim 4, wherein the pair of rails is positioned between the pair of sawhorses.

8. The workpiece support assembly of claim 4, wherein the pair of rails is perpendicular to the pair of cross members.

9. The workpiece support assembly of claim 4, further comprising a rail clamp being coupled to each rail of the pair of rails, the rail clamp being configured to releasably engage a workpiece wherein the rail clamp is configured to releasably secure the workpiece to each rail of the pair of rails.

10. The workpiece support assembly of claim 9, the rail clamp further comprising:
a rail clamp primary arm being telescopically coupled to a rail primary end of each rail of the pair of rails, the rail clamp primary arm being nested within the rail primary end wherein the rail clamp primary arm is extendable and retractable relative to the rail primary end;
a rail clamp primary fin being coupled to the rail clamp primary arm, the rail clamp primary fin extending upwardly from the rail clamp primary arm wherein the rail clamp primary fin is configured to hold an edge of the workpiece to releasably secure the workpiece to the rail primary end of each rail of the pair of rails;
a rail clamp secondary arm being telescopically coupled to a rail secondary end of each rail of the pair of rails, the rail clamp secondary arm being nested within the rail secondary end wherein the rail clamp secondary arm is extendable and retractable relative to the rail secondary end; and
a rail clamp secondary fin being coupled to the rail clamp secondary arm, the rail clamp secondary fin extending upwardly from the rail clamp secondary arm wherein the rail clamp secondary fin is configured to hold the edge of the workpiece to releasably secure the workpiece to the rail secondary end of each rail of the pair of rails.

11. The workpiece support assembly of claim 1, wherein the pair of cross members is perpendicular to the sawhorse beam of each sawhorse of the pair of sawhorses.

12. The workpiece support assembly of claim 1, wherein the pair of cross members is removably couplable to each sawhorse of the pair of sawhorses.

13. The workpiece support assembly of claim 12, further comprising a pair of beam notches extending into the sawhorse beam upper surface of the sawhorse beam of each sawhorse of the pair of sawhorses, the pair of cross members being positionable within the pair of beam notches to removably couple the pair of beams to each sawhorse of the pair of sawhorses.

14. The workpiece support assembly of claim 13, wherein each beam notch of the pair of beam notches is positioned between a sawhorse beam center and a respective sawhorse beam lateral end of a pair of sawhorse beam lateral ends of the sawhorse beam of each sawhorse of the pair of sawhorses.

15. The workpiece support assembly of claim 1, each cross member of the pair of cross members further comprising:
a break extending through the cross member to define a cross member first portion and a cross member second portion; and
a cross member hinge pivotably coupling the cross member first portion to the cross member second portion wherein the cross member is pivotable between a cross member storage position and a cross member extended position, the cross member first portion being folded against the cross member second portion when the cross member is in the cross member storage position.

16. The workpiece support assembly of claim 15, wherein the cross member hinge is positioned on a cross member bottom surface of the cross member wherein the cross member top surface of the cross member first portion faces away from the cross member top surface of the cross member second portion when the cross member is in the cross member storage position.

17. The workpiece support assembly of claim 15, wherein the break is centrally positioned between the cross member first end and the cross member second end wherein the cross member first portion has a cross member first portion length being equivalent to a cross member second portion length of the cross member second portion.

18. The workpiece support assembly of claim 15, further comprising a retainer being coupled to each cross member of the pair of cross members, the retainer being positioned on the cross member second portion of each cross member of the pair of cross members, the retainer releasably engaging the cross member first portion when each cross member of the pair of cross members is in the cross member storage position wherein the retainer inhibits each cross member of the pair of cross members from unfolding into the cross member extended position.

19. A workpiece support assembly comprising:
a pair of sawhorses being couplable together, the pair of sawhorses being spaced from each other, the pair of sawhorses being parallel to each other, each sawhorse of the pair of sawhorses including:
a sawhorse beam having a sawhorse beam upper surface, a sawhorse beam lower surface, and a pair of sawhorse beam lateral ends;
a pair of supports being coupled to the sawhorse beam, the pair of supports extending downwardly from the sawhorse beam lower surface wherein the pair of supports is configured to position the sawhorse beam above a ground surface, the sawhorse beam being removably couplable to the pair of supports, each support of the pair of supports being positioned proximate to a respective sawhorse beam lateral end of the pair of sawhorse beam lateral ends wherein the pair of supports are spaced from each other, each support of the pair of supports including:
a pair of legs extending outwardly and downwardly from opposing sides of the sawhorse beam, the sawhorse beam being positionable between the pair of legs, the pair of legs being pivotably coupled together wherein the pair of legs are pivotable toward each other when the sawhorse beam is removed from between the pair of legs; and
a leg hinge coupling the pair of legs together, the leg hinge being positioned beneath the sawhorse beam when the sawhorse beam is coupled to the pair of legs; and
a pair of beam notches extending into the sawhorse beam upper surface of the sawhorse beam, the pair of beam notches being spaced from each other wherein each beam notch of the pair of beam notches is positioned between a sawhorse beam center and an associated sawhorse beam lateral end of the pair of sawhorse beam lateral ends, each support of the pair of supports being positioned between the pair of beam notches and the associated sawhorse beam lateral end of the pair of sawhorse beam lateral ends;
a pair of cross members being coupled to the pair of sawhorses, the pair of cross members extending between the pair of sawhorses wherein the pair of cross members couples the pair of sawhorses together, the pair of cross members being perpendicular to the sawhorse beam of each sawhorse of the pair of sawhorses, the pair of cross members being removably couplable to each sawhorse of the pair of sawhorses, the pair of cross members being positioned within the pair of beam notches when the pair of cross members are coupled to each sawhorse of the pair of sawhorses, each cross member of the pair of cross members including:
a cross member first end being positioned proximate to a first sawhorse of the pair of sawhorses;
a cross member second end being positioned proximate to a second sawhorse of the pair of sawhorses;
a cross member length between the cross member first end and the cross member second end exceeding a distance between the pair of sawhorses wherein the cross member extends past each of the pair of sawhorses;
a cross member width being complementary to a respective beam notch width of each beam notch of the pair of beam notches wherein the cross member is positionable within each beam notch of the pair of beam notches;
a cross member top surface, the cross member having a cross member height being complementary to a respective beam notch height of each beam notch of the pair of beam notches wherein the cross member top surface is coplanar with the sawhorse beam upper surface of the sawhorse beam when each cross member of the pair of cross members is coupled to the pair of sawhorses;
a cross member bottom surface being spaced from the sawhorse beam lower surface;
a break extending through the cross member to define a cross member first portion and a cross member second portion, the break being centrally positioned along the cross member length wherein the cross member first portion has a cross member first portion length being equivalent to a cross member second portion length of the cross member second portion, the cross member first end being positioned on the cross member first portion, the cross member second end being positioned on the cross member second portion; and
a cross member hinge pivotably coupling the cross member first portion to the cross member second portion wherein the cross member is pivotable between a cross member storage position and a cross member extended position, the cross member first portion being folded against the cross member second portion when the cross member is in the cross member storage position, the cross member hinge being positioned on the cross member bottom surface of the cross member wherein the cross member top surface of the cross member first portion faces away from the cross member top surface of the cross member second portion when the cross member is in the cross member storage position, the cross member first portion being parallel to the cross member second portion when the cross member is in the cross member extended position, the cross member top surface of the cross member first portion being coplanar with the cross member top surface of the cross member second portion when the cross member is in the cross member extended position;
a pair of rails being coupled to the pair of cross members, the pair of rails extending between the pair of cross members, the pair of rails being perpendicular to the pair of cross members, the pair of rails being spaced from each other, the pair of rails being positioned between the pair of sawhorses when the pair of cross members is coupled to the pair of sawhorses, each rail of the pair of rails including:
a rail primary end being positioned proximate to a first cross member of the pair of cross members;
a rail secondary end being positioned proximate to a second cross member of aid pair of cross members;
a rail length between the rail primary end and the rail secondary end exceeding a distance between the pair of cross members wherein the pair of rails extend past each cross member of the pair of cross members, the rail length exceeding a sawhorse beam length between the pair of sawhorse beam lateral ends;
a rail top side being coplanar with the cross member top surface; and
a rail bottom side being coplanar with the cross member bottom surface;
a cross member clamp being coupled to each cross member of the pair of cross members, the cross member clamp being configured to releasably engage a workpiece wherein the cross member clamp is configured to releasably secure the workpiece to each cross member of the pair of cross members, the cross member clamp including:
a cross member first portion clamp arm being telescopically coupled to the cross member first portion, the cross member first portion clamp arm being nested within the cross member first portion wherein the cross member first portion clamp arm is extendable and retractable relative to the cross member first end of each cross member of the pair of cross members; and
a cross member first portion clamp fin being coupled to the cross member first portion clamp arm, the cross member first portion clamp fin extending upwardly from the cross member first portion clamp arm wherein the cross member first portion clamp fin is configured to hold an edge of the workpiece to releasably secure the workpiece to the cross member first portion of each cross member of the pair of cross members;
a cross member second portion clamp arm being telescopically coupled to the cross member second portion, the cross member second portion clamp arm being nested within the cross member second portion wherein the cross member second portion clamp arm is extendable and retractable relative to the cross member second end of each cross member of the pair of cross members; and
a cross member second portion clamp fin being coupled to the cross member second portion clamp arm, the cross member second portion clamp fin extending upwardly from the cross member second portion clamp arm wherein the cross member second portion clamp fin is configured to hold the edge of the workpiece to releasably secure the workpiece to the cross member second portion of each cross member of the pair of cross members;
a rail clamp being coupled to each rail of the pair of rails, the rail clamp being configured to releasably engage the workpiece wherein the rail clamp is configured to releasably secure the workpiece to each rail of the pair of rails, the rail clamp including:
a rail clamp primary arm being telescopically coupled to the rail primary end of each rail of the pair of rails, the rail clamp primary arm being nested within the rail primary end wherein the rail clamp primary arm is extendable and retractable relative to the rail primary end;
a rail clamp primary fin being coupled to the rail clamp primary arm, the rail clamp primary fin extending upwardly from the rail clamp primary arm wherein the rail clamp primary fin is configured to hold the edge of the workpiece to releasably secure the workpiece to the rail primary end of each rail of the pair of rails;
a rail clamp secondary arm being telescopically coupled to the rail secondary end of each rail of the pair of rails, the rail clamp secondary arm being nested within the rail secondary end wherein the rail clamp secondary arm is extendable and retractable relative to the rail secondary end; and
a rail clamp secondary fin being coupled to the rail clamp secondary arm, the rail clamp secondary fin extending upwardly from the rail clamp secondary arm wherein the rail clamp secondary fin is configured to hold the edge of the workpiece to releasably secure the workpiece to the rail secondary end of each rail of the pair of rails;
a retainer being coupled to each cross member of the pair of cross members, the retainer being positioned on the cross member second portion of each cross member of the pair of cross members, the retainer releasably engaging the cross member first portion when each cross member of the pair of cross members is in the cross member storage position wherein the retainer inhibits each cross member of the pair of cross members from unfolding into the cross member extended position, the retainer including:
a first strap being coupled to a first cross member of the pair of cross members, the first strap being positioned adjacent to the cross member second end of the first cross member, the first strap extending downwardly from the first cross member; and
a second strap being coupled to a second cross member of the pair of cross members, the second strap being positioned adjacent to the cross member second end of the second cross member, the second strap extending downwardly from the second cross member, the second strap being aligned with the first strap.
